(19) United States
(12) Patent Application Publication
(10) Pub. No.: US 2025/0350227 A1
(43) Pub. Date: Nov. 13, 2025

(54) ROTATION AMOUNT ESTIMATION DEVICE, ROTATION AMOUNT ESTIMATION METHOD, AND MOTOR CONTROL DEVICE

(71) Applicant: DENSO CORPORATION, Kariya-city (JP)

(72) Inventor: Shozen KUDO, Kariya-city (JP)

(21) Appl. No.: 19/271,051

(22) Filed: Jul. 16, 2025

Related U.S. Application Data
(63) Continuation of application No. PCT/JP2024/000512, filed on Jan. 12, 2024.

(30) Foreign Application Priority Data
Jan. 23, 2023 (JP) 2023-008277

(51) Int. Cl. H02P 23/14; E05F 15/695; E05F 15/697

(52) U.S. Cl. CPC H02P 23/14; E05F 15/695; E05F 15/697; E05Y 2201/408; E05Y 2400/302; E05Y 2400/36; E05Y 2400/564; E05Y 2900/55

(57) ABSTRACT

A curve estimation unit estimates, when a DC motor stops rotation through a braking operation by stopping supply of a drive current to the DC motor and applying a same potential to both terminals of the DC motor, an attenuation characteristic curve of an induced current from start of the braking operation to stop of the rotation of the DC motor, based on the induced current flowing through the DC motor in the braking operation. A time estimation unit estimates a time required from the start of the braking operation to the stop of the rotation of the DC motor. A rotation amount estimation unit estimates the rotation amount of the DC motor in the braking operation based on an integral value obtained by integrating the induced current over the time as estimated according to the attenuation characteristic curve of the induced current as estimated.

### CROSS REFERENCE TO RELATED APPLICATION

The present application is a continuation application of International Patent Application No. PCT/JP2024/000512 filed on Jan. 12, 2024, which designated the U.S. and claims the benefit of priority from Japanese Patent Application No. 2023-008277 filed on Jan. 23, 2023. The entire disclosures of all of the above applications are incorporated herein by reference.

### TECHNICAL FIELD

The present disclosure relates to a rotation amount estimation device, a rotation amount estimation method, and a motor control device.

### BACKGROUND

Conventionally, a device that detects rotation information of a motor on the basis of motor drive waveforms is known.

### SUMMARY

According to an aspect of the present disclosure, a rotation amount estimation device is configured to estimate a rotation amount of a brushed DC motor in a braking operation. The rotation amount estimation device may comprise: at least one of (i) a circuit and (ii) a processor with a memory storing computer program code executable by the processor, the at least one of the circuit and the processor configured to cause the rotation amount estimation device to: estimate, when the DC motor stops rotation through the braking operation of the DC motor by stopping supply of a drive current to the DC motor and applying a same potential to both terminals of the DC motor, an attenuation characteristic curve indicating a characteristic of attenuation of an induced current from start of the braking operation to stop of the rotation of the DC motor, based on the induced current flowing through the DC motor in the braking operation of the DC motor; estimate a time required from the start of the braking operation to the stop of the rotation of the DC motor; and estimate the rotation amount of the DC motor in the braking operation based on an integral value obtained by integrating the induced current over the time as estimated according to the attenuation characteristic curve of the induced current as estimated.

### BRIEF DESCRIPTION OF DRAWINGS

FIG. 1 is a schematic configuration view schematically illustrating configurations of a during-braking rotation amount estimation device and a motor control device according to an embodiment.

FIG. 2 is a time chart illustrating changes in signals of respective units, including a motor current, when the operation state of a DC motor is switched from a normal operation to a braking operation.

FIG. 3 is an explanatory view for explaining a method for estimating an attenuation characteristic curve of an induced current.

FIG. 4 is a view illustrating an actual induced current integral value.

FIG. 5 is a view illustrating a reference induced current integral value.

FIG. 6 is a flowchart illustrating a process for calculating the rotation amount of a DC motor in a braking operation by a motor control device according to a first embodiment.

FIG. 7 is a time chart illustrating that a motor control device according to a second embodiment completes measurement at at least three measurement points for deriving an attenuation characteristic curve before a motor current becomes zero.

FIG. 8 is a flowchart illustrating a process for calculating the rotation amount of a DC motor in a braking operation by the motor control device according to the second embodiment.

### DETAILED DESCRIPTION

Hereinafter, examples of the present disclosure will be described.

According to an example of the present disclosure, a device detects rotation information of a motor on the basis of a motor drive waveform of a current flowing through a DC motor having a brush, a voltage across the terminals of the motor, or the like.

This device generates a pulse signal of a ripple component from the waveform of the detected motor current. The rotation amount of the motor is estimated based on the pulse signal. A back electromotive voltage is estimated from a motor terminal voltage and the detected motor current. Then, an integral calculation is performed on the back electromotive voltage for each pulse period of the pulse signal to obtain an integral value indicating the rotation amount of the motor. The estimated rotation amount of the motor is corrected based on the integral value.

When the motor is stopped, this device switches the motor from a steady operation state to a braking operation state by connecting both terminals of the motor to the ground potential. However, when the motor is switched to the braking operation state, both the terminals of the motor have the same ground potential. Therefore, it is difficult to detect the correct motor terminal voltage, and as a result, it is also difficult to accurately estimate the back electromotive voltage from a motor terminal voltage and the detected motor current.

In this device, integration of a back electromotive force is repeated for each pulse period of the pulse signal. In the braking operation state, however, the rotation speed decreases and the ripple component also decreases, and hence it is also difficult to accurately obtain the pulse period of the pulse signal. Therefore, there is a risk that the integration of the back electromotive force cannot be correctly performed.

For these reasons, it is very difficult in the braking operation state to obtain the accurate rotation amount of the motor using the back electromotive force.

According to an example of the present disclosure, a rotation amount estimation device is configured to estimate a rotation amount of a brushed DC motor in a braking operation. The rotation amount estimation device includes: at least one of (i) a circuit and (ii) a processor with a memory storing computer program code executable by the processor, the at least one of the circuit and the processor configured to cause the rotation amount estimation device to: estimate, when the DC motor stops rotation through the braking operation of the DC motor by stopping supply of a drive current to the DC motor and applying a same potential to both terminals of the DC motor, an attenuation characteristic curve indicating a characteristic of attenuation of an induced current from start of the braking operation to stop of the rotation of the DC motor, based on the induced current flowing through the DC motor in the braking operation of the DC motor; estimate a time required from the start of the braking operation to the stop of the rotation of the DC motor; and estimate the rotation amount of the DC motor in the braking operation based on an integral value obtained by integrating the induced current over the time as estimated according to the attenuation characteristic curve of the induced current as estimated.

According to an example of the present disclosure, a rotation amount estimation method is for estimating a rotation amount of a brushed DC motor in a braking operation executed by at least one processor. The rotation amount estimation method includes: first estimating, when rotation of the DC motor is stopped through the braking operation of the DC motor by stopping supply of a drive current to the DC motor and applying a same potential to both terminals of the DC motor, an attenuation characteristic curve indicating a characteristic of attenuation of an induced current from start of the braking operation to stop of the rotation of the DC motor, based on the induced current flowing through the DC motor in the braking operation of the DC motor; second estimating a time required from the start of the braking operation to the stop of the rotation of the DC motor; and third estimating the rotation amount of the DC motor in the braking operation based on an integral value obtained by integrating the induced current over the time as estimated according to the attenuation characteristic curve of the induced current as estimated.

According to the rotation amount estimation device and the rotation amount estimation method described above, an induced current is used, instead of the back electromotive force, to estimate the rotation amount of the DC motor in a braking operation. When the DC motor performs a braking operation by applying the same potential to both terminals of the DC motor, an induced current, corresponding to the rotation speed of the DC motor, flows through the DC motor via a circuit for applying the same potential. Therefore, by integrating the induced current over the time from the start of the braking operation of the DC motor to the stop of the rotation, the integral value becomes a value corresponding to the rotation amount of the DC motor during the braking operation. Therefore, the rotation amount of the DC motor during the braking operation can be estimated on the basis of the integral value of the induced current, and the estimation accuracy can be improved compared to conventional methods.

According to an example of the present disclosure, a motor control device includes the rotation amount estimation device. The at least one of the circuit and the processor is configured to cause the rotation amount estimation device to: detect a rotation amount when the DC motor is stopped by adding the rotation amount of the DC motor in the braking operation as estimated to the rotation amount of the DC motor until the supply of the drive current to the DC motor is stopped, the rotation amount being calculated based on the waveform of a current flowing through the DC motor; and control the supply of the drive current to the DC motor based on the rotation amount of the DC motor as detected.

The motor control device includes the rotation amount estimation device, thereby to enable to detect the rotation amount when the DC motor stops. Therefore, the motor control device enables to control supply of the DC current to the DC motor based on the rotation amount of the DC motor as detected.

### First Embodiment

Hereinafter, a during-braking rotation amount estimation device, a during-braking rotation amount estimation method, and a motor control device including the during-braking rotation amount estimation device, according to a first embodiment of the present disclosure, will be described in detail with reference to the drawings. Note that the same or similar configurations are denoted by the same reference numerals in a plurality of drawings, and thus the description thereof may be omitted.

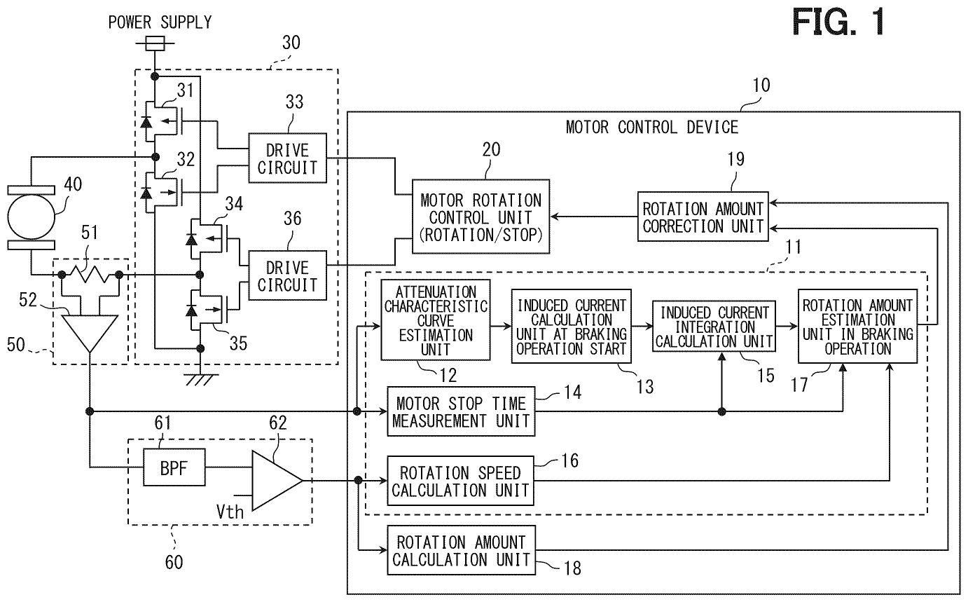

FIG. 1 is a schematic configuration view schematically illustrating configurations of a during-braking rotation amount estimation device 11, and a motor control device 10 including the during-braking rotation amount estimation device 11, according to the present embodiment. FIG. 1 also illustrates a brushed DC motor (hereinafter, referred to as a DC motor) 40 to be controlled, a motor drive unit 30 that applies a drive current to the DC motor 40 according to a control signal from the motor control device 10, a motor current monitoring unit 50 that detects a current supplied to the DC motor 40, and a rotation signal generation unit 60 that generates a rotation signal according to the rotation of the DC motor 40 on the basis of an output signal of the motor current monitoring unit 50.

The DC motor 40 includes, for example, a rotor formed of a laminated iron core around which a coil is wound, and a stator formed of a permanent magnet. When the rotor rotates in a magnetic field, a commutator attached to the rotor also rotates, and brushes with which the commutator is in contact switch places. Every time the brushes with which the commutator is in contact switch places, the direction of the current flowing through the coil is switched, so that the rotor continues to rotate and the DC motor 40 is rotationally driven.

The DC motor 40 can be used as, for example, a motor for opening and closing a window of a vehicle. In addition, the DC motor 40 can be used as an actuator for driving the air mix door in an air conditioner, a door mirror, or the like in a vehicle. Furthermore, the DC motor 40 may be used as an actuator for driving various equipment other than vehicle equipment mounted on a vehicle.

According to the motor control device 10 of the present embodiment, a braking operation, in which the same potential is applied to both terminals of the DC motor 40, is performed when the DC motor 40 is stopped, so that the time until the rotation of the DC motor 40 is stopped can be shortened, as will be described in detail later. Furthermore, in the present embodiment, with the motor control device 10 including the during-braking rotation amount estimation device 11, the rotation amount of the DC motor 40 during the braking operation can be estimated with high accuracy. Therefore, even if the DC motor 40 is repeatedly stopped and restarted, the rotational position of the DC motor 40 can be accurately detected. For these reasons, the motor control device 10 including the during-braking rotation amount estimation device 11, according to the present embodiment, is suitable for the application of controlling a DC motor that opens and closes a window of a vehicle.

Here, in a case where the opening and closing of a window of a vehicle is controlled by the DC motor 40, and if pinch by the window occurs in the middle of closing the window, anti-pinch control for stopping or reversing the DC motor 40 is generally executed. However, there is a risk that, if the anti-pinch control is effective when the window of a vehicle reaches a position where it is in contact with the window weatherstrip, contact with the window weatherstrip may be erroneously detected as pinch. Therefore, it is necessary to stop (invalidate) the anti-pinch control immediately before the window comes into contact with the window weatherstrip. However, in a case where the position of the window is detected on the basis of the rotation amount of the DC motor 40, and if there is an error in the rotation amount of the DC motor 40, there is a risk that the anti-pinch control cannot be stopped at an appropriate window position such as a position immediately before the window comes into contact with the window weatherstrip. In this regard, in the present embodiment, the rotation amount of the DC motor 40 can be accurately detected even if the stop and the restart are repeated, so that the anti-pinch control can be stopped at an appropriate window position. For example, it is only required that when it is determined on the basis of the detected rotation amount of the DC motor 40 that a predetermined distance to the position where the window is closed has been reached, the anti-pinch control is stopped.

The motor drive unit 30 includes four switching elements (e.g., a MOS transistor, an IGBT, and the like) 31, 32, 34, and 35 and two drive circuits 33 and 36. Freewheeling diodes are connected in anti-parallel to the four switching elements 31, 32, 34, and 35, respectively. The four switching elements 31, 32, 34, and 35 form an H-bridge circuit for driving the DC motor 40. The drive circuit 33 controls conduction states (on or off) of the switching elements 31 and 32 according to a control signal from the motor control device 10. The drive circuit 36 controls conduction states of the switching elements 34 and 35 according to a control signal from the motor control device 10.

For example, when rotating the DC motor 40 forward, the motor control device 10 turns on the switching elements 31 and 35 and turns off the switching elements 32 and 34 via the drive circuits 33 and 36. Conversely, when rotating the DC motor 40 in reverse, the motor control device 10 turns on the switching elements 32 and 34 and turns off the switching elements 31 and 35 via the drive circuits 33 and 36. Furthermore, when performing a braking operation to stop the rotation of the DC motor 40 from a normal operation to rotate the DC motor 40 forward or in reverse, the motor control device 10 turns on the switching elements 32 and 35 or the switching elements 31 and 34 via the drive circuits 33 and 36 to apply the same potential (ground potential or power supply potential) to both the terminals of the DC motor 40.

The motor current monitoring unit 50 includes a shunt resistor 51 connected in series with the DC motor 40 in a power supply circuit for the DC motor 40. Furthermore, the motor current monitoring unit 50 includes a differential amplifier circuit 52 that amplifies the voltage across both terminals of the shunt resistor 51 according to the current supplied to the DC motor 40. The output signal amplified by the differential amplifier circuit 52 is input to the motor control device 10 and the rotation signal generation unit 60.

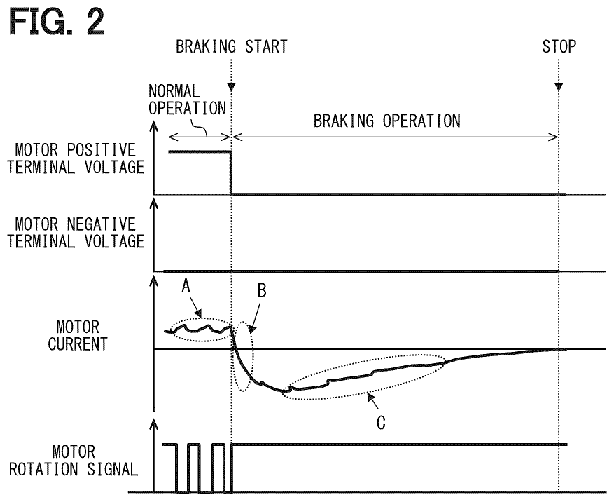

The rotation signal generation unit 60 includes a band-pass filter 61 that performs band-pass filtering on the signal input from the motor current monitoring unit 50. The signal input from the motor current monitoring unit 50 includes a ripple component of the current flowing through the DC motor 40, which is generated every time the DC motor 40 rotates by a predetermined angle, as illustrated as the “motor current” in FIG. 2. The band-pass filter 61 allows a signal in the frequency band of the ripple component to pass through. As a result, the band-pass filter 61 removes noise having a frequency other than the frequency of the ripple component, and outputs a signal corresponding to the ripple component of the current flowing through the DC motor 40.

The rotation signal generation unit 60 further includes a comparator 62 that compares the signal output from the band-pass filter 61 to a threshold Vth. The comparator 62 is configured, for example, to output a Lo-level signal when the output signal from the band-pass filter 61 is larger than the threshold Vth and output a Hi-level signal when the output signal from the band-pass filter 61 is smaller than the threshold Vth. In this case, the comparator 62 outputs a pulse signal that changes from the Hi-level to the Lo-level by a ripple component generated every time the DC motor 40 rotates by a predetermined angle, the Lo-level continuing while the ripple component is larger than the threshold Vth. In the example illustrated in FIG. 2, the pulse signal output from the comparator 62 is illustrated as the “motor rotation signal”.

The motor control device 10 can be configured by a known computer including a CPU as at least one processor, a ROM and a RAM as memories, an I/O circuit for exchanging signals with the outside, and the like. In the motor control device 10, various processes are executed by the CPU according to programs stored, for example, in the ROM. As an example, the motor control device 10 generates and outputs a control signal for controlling the DC motor 40 on the basis of the output signal from the motor current monitoring unit 50 and the motor rotation signal from the rotation signal generation unit 60. The start or stop of the drive of the DC motor 40 is instructed to the motor control device 10 by an external control device, a switch, or the like (not illustrated).

Here, FIG. 1 illustrates, as a block, each function exhibited by the motor control device 10 by execution of a program. As illustrated in FIG. 1, the motor control device 10 includes the during-braking rotation amount estimation device 11, a rotation amount calculation unit 18, a rotation amount correction unit 19, and a motor rotation control unit 20.

When the motor control device 10 performs the braking operation to stop the rotation of the DC motor 40 from the normal operation to rotate the DC motor 40 forward or in reverse, the during-braking rotation amount estimation device 11 estimates the rotation amount of the DC motor 40 during the braking operation. The during-braking rotation amount estimation device 11 will be described in detail later.

The rotation amount calculation unit 18 calculates the rotation amount after the normal operation of the DC motor 40 is started on the basis of the motor rotation signal output by the rotation signal generation unit 60. As described above, the motor rotation signal is a pulse signal that is turned on and off every time the DC motor 40 rotates by a predetermined angle. Therefore, the rotation amount calculation unit 18 can calculate the rotation amount after the normal operation of the DC motor 40 is started, by counting the number of pulses of the motor rotation signal.

The rotation amount correction unit 19 corrects the rotation amount calculated by the rotation amount calculation unit 18 using the rotation amount of the DC motor 40 during the braking operation provided by the during-braking rotation amount estimation device 11 when the DC motor 40 stops through the braking operation. Specifically, the rotation amount correction unit 19 calculates the rotation amount of the stopped DC motor 40 by adding the rotation amount of the DC motor 40 during the braking operation estimated by the during-braking rotation amount estimation device 11 to the rotation amount calculated by the rotation amount calculation unit 18. As described above, by adding the rotation amount of the DC motor 40 during the braking operation estimated by the during-braking rotation amount estimation device 11 to the rotation amount of the DC motor 40 calculated by the rotation amount calculation unit 18, the rotation amount when the DC motor 40 stops can be accurately detected.

The motor rotation control unit 20 controls the supply of a drive current to the DC motor 40 by generating a control signal on the basis of the rotation amount of the DC motor 40 detected by the rotation amount correction unit 19. For example, during the normal operation in which the DC motor 40 is rotated forward or in reverse, the rotation amount is not provided from the during-braking rotation amount estimation device 11. Therefore, the rotation amount correction unit 19 detects the rotation amount of the DC motor 40 only on the basis of the rotation amount estimated by the rotation amount calculation unit 18. Then, for example, in a case where the DC motor 40 is used as a motor that opens and closes a window of a vehicle, the motor control device 10 stops the anti-pinch control when it is determined on the basis of the rotation amount of the DC motor 40 detected by the rotation amount correction unit 19 that a predetermined distance to the position where the window is closed has been reached. In this case, even if the window is in contact with the window weatherstrip, the motor rotation control unit 20 can continue the normal operation of the DC motor 40. Then, when it is determined on the basis of the rotation amount of the DC motor 40 detected by the rotation amount correction unit 19 that the window of the vehicle has reached the closed position, the motor rotation control unit 20 outputs a control signal for stopping the supply of the drive current to the DC motor 40.

When stop of the rotation of the DC motor 40 is instructed to the motor control device 10 by an external control device, a switch, or the like (not illustrated) while the window of the vehicle is being closed, the motor rotation control unit 20 sends a control signal to the motor drive unit 30 so as to stop the supply of the drive current to the DC motor 40 and apply the same potential to both the terminals of the DC motor 40. In this case, the rotation of the DC motor 40 stops through the braking operation. Since the motor control device 10 includes the during-braking rotation amount estimation device 11, the rotation amount of the DC motor 40 during the braking operation can be estimated with high accuracy. Therefore, even if the DC motor 40 is repeatedly stopped and restarted, the rotation amount correction unit 19 can accurately detect the rotation amount of the DC motor 40.

Next, the during-braking rotation amount estimation device 11 according to the present embodiment will be described. As described above, the during-braking rotation amount estimation device 11 estimates the rotation amount of the DC motor 40 during the braking operation using the induced current instead of the back electromotive force. When the DC motor 40 performs a braking operation by applying the same potential to both the terminals of the DC motor 40, an induced current flows through the DC motor 40 via the circuit for applying the same potential. The magnitude of the induced current corresponds to the rotation speed of the DC motor 40. Therefore, by integrating the induced current over the time from the start of the braking operation of the DC motor 40 to the stop of the rotation, the integral value becomes a value corresponding to the rotation amount of the DC motor 40 during the braking operation. Therefore, the rotation amount of the DC motor 40 during the braking operation can be estimated on the basis of the integral value of the induced current.

FIG. 2 is a time chart illustrating changes in signals of respective units, including a motor current, when the operation state of the DC motor 40 is switched from the normal operation to the braking operation. During the normal operation, for example, a predetermined drive voltage is applied across the positive terminal and the negative terminal of the DC motor 40, as illustrated in FIG. 2. The applied drive voltage causes a drive current to flow through the coil of the rotor of the DC motor 40, which rotates the rotor.

During the normal operation, which is the period indicated by “A” in FIG. 2, a combined current of the drive current and the induced current flows through the DC motor 40 as the motor current. In addition, the above-described ripple component is generated in the motor current. During the period, which is the period indicated by “B” in FIG. 2, immediately after the switching from the normal operation to the braking operation, the motor current sharply swings in the reverse direction due to the braking operation. Immediately after the start of the braking, however, switching from the combined current to the induced current is delayed due to the influence of the inductance of the coil of the DC motor 40. Therefore, during the period immediately after the start of the braking, the correct induced current cannot be measured from the motor current. During the period indicated by “C” in FIG. 2, the switching from the combined current to the induced current is completed, and the induced current can be measured from the motor current.

During the period indicated by “C”, the rotation speed of the DC motor 40 decreases, and hence the amplitude of the ripple component decreases, as illustrated in FIG. 2. Therefore, the ripple component passing through the band-pass filter 61 may not exceed the threshold of the comparator 62 in the rotation signal generation unit 60. Therefore, it is difficult during the period indicated by “C” to estimate the rotation amount of the DC motor 40 from the motor rotation signal output from the rotation signal generation unit 60.

In view of the characteristics of the induced current as described above, a configuration adopted by the during-braking rotation amount estimation device 11 according to the present embodiment for integrating the induced current from the start of the braking operation to the stop of the rotation of the DC motor 40 will be described below.

First, the during-braking rotation amount estimation device 11 includes an attenuation characteristic curve estimation unit 12. Based on the induced current flowing through the DC motor 40 during the braking operation of the DC motor 40, the attenuation characteristic curve estimation unit 12 estimates an attenuation characteristic curve indicating a characteristic of attenuation of the induced current from the start of the braking operation to the stop of the rotation of the DC motor 40.

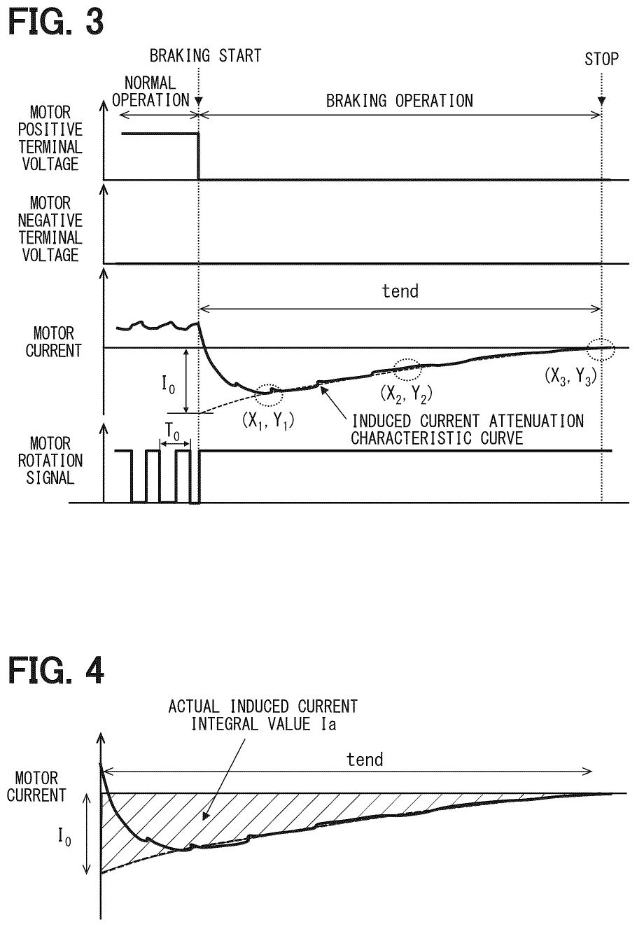

However, the induced current cannot be measured from the motor current immediately after the start of the braking, as described above. Therefore, the attenuation characteristic curve estimation unit 12 measures the values of the induced current output from the motor current monitoring unit 50 and the time when each of the values of the induced current is obtained at at least three measurement points (X₁, Y₁), (X₂, Y₂), and (X₃, Y₃) after the motor current indicates the induced current during the braking operation of the DC motor 40, as illustrated, for example, in FIG. 3. Note that X₁, X₂, and X₃ represent the times when the respective induced current values are obtained, and Y₁, Y₂, and Y₃ represent the respective induced current values.

Whether the motor current indicates the induced current can be determined on the basis of whether the motor current is sharply swung in the reverse direction and reaches a peak. Therefore, measurement at the at least three measurement points described above is performed after the motor current reaches the peak during the braking operation. For example, in the example illustrated in FIG. 3, measurement at the first measurement point (X₁, Y₁) is performed immediately after the motor current reaches the peak. Measurement at the third measurement point (X₃, Y₃) is performed when the motor current becomes substantially zero. Measurement at the second measurement point (X₂, Y₂) is performed at around the approximate midpoint between the first measurement point (X₁, Y₁) and the third measurement point (X₃, Y₃).

The attenuation characteristic curve estimation unit 12 derives an attenuation characteristic curve of the induced current on the basis of the measured values at the at least three measurement points (X₁, Y₁), (X₂, Y₂), and (X₃, Y₃). Specifically, the attenuation characteristic curve can be represented by a substantially quadratic function curve, as indicated by the dotted line in FIG. 3. Therefore, for example, the quadratic function curve is defined as y=ax²+bx+c, and the measured values at the three measurement points (X₁, Y₁), (X₂, Y₂), and (X₃, Y₃) are substituted into the equation of the quadratic function curve. As a result, the coefficients a, b, and c of the quadratic function curve can be calculated. In this way, the attenuation characteristic curve estimation unit 12 can estimate the attenuation characteristic curve indicating the attenuation characteristic of the induced current.

An induced current calculation unit 13 at the start of the braking operation calculates, by computation, an induced current value lo when the braking operation of the DC motor 40 is started, from the attenuation characteristic curve derived by the attenuation characteristic curve estimation unit 12.

Based on the motor current input from the motor current monitoring unit 50, a motor stop time measurement unit 14 measures a time, tend, from the start of the braking operation until the motor current becomes substantially zero, that is, until the rotation of the DC motor 40 stops.

Based on the attenuation characteristic curve estimated by the attenuation characteristic curve estimation unit 12 and the time, tend, until the rotation of the DC motor 40 stops measured by the motor stop time measurement unit 14, an induced current integration calculation unit 15 calculates an actual induced current integral value la during the braking operation period by integrating the induced current over the time, tend, according to the attenuation characteristic curve of the induced current, as illustrated by the shaded portion in FIG. 4.

A rotation speed calculation unit 16 calculates the rotation speed of the DC motor 40 on the basis of the motor rotation signal from the rotation signal generation unit 60.

Based on the rotation speed of the DC motor calculated by the rotation speed calculation unit 16, a rotation amount estimation unit 17 during the braking operation estimates the rotation speed of the DC motor 40 at the time when the braking operation is started. For example, as illustrated in FIG. 3, the rotation amount estimation unit 17 during the braking operation can set a rotation speed V₀, calculated by the rotation speed calculation unit 16 from a cycle T₀ between two pulse signals immediately before the braking operation is started, to be the rotation speed of the DC motor 40 at the time when the braking operation of the DC motor 40 is started.

In addition, the rotation amount estimation unit 17 during the braking operation calculates the product of the rotation speed V₀ of the DC motor at the time when the braking operation of the DC motor 40 is started and the time, tend, from the start of the braking operation to the stop of the rotation of the DC motor 40 measured by the motor stop time measurement unit 14, as a reference rotation amount Ns. That is, the reference rotation amount Ns corresponds to the rotation amount of the DC motor 40 when it is assumed that the DC motor 40 rotates over the time, tend, with the rotation speed V₀ of the DC motor, at the time when the braking operation of the DC motor 40 is started, maintained.

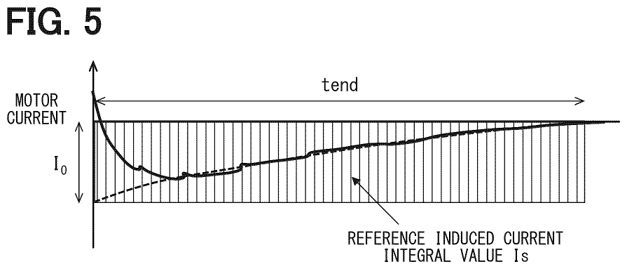

Furthermore, the rotation amount estimation unit 17 during the braking operation calculates the product of the induced current value I₀ when the braking operation of the DC motor 40 is started and the time, tend, from the start of the braking operation to the stop of the rotation of the DC motor 40 as a reference induced current integral value Is, as illustrated in FIG. 5. That is, the reference induced current integral value Is corresponds to an integral value of the induced current when it is assumed that the magnitude of the induced current flowing through the DC motor 40, that is, the induced current value I₀, when the braking operation of the DC motor 40 is started, is maintained over the time, tend.

Then, the rotation amount estimation unit 17 during the braking operation calculates a rotation amount Na of the DC motor 40 during the braking operation by multiplying the reference rotation amount Ns by the ratio of the actual induced current integral value la to the reference induced current integral value Is. That is, the rotation amount Na of the DC motor 40 during the braking operation can be calculated by the following equation 1: (Equation 1) Na=Ns×(Ia/Is).

In the above example, the reference rotation amount Ns and the reference induced current integral value Is are calculated when the DC motor 40 is operated in a braking mode. However, the reference rotation amount Ns and the reference induced current integral value Is need not necessarily be calculated every time the DC motor 40 is operated in a braking mode. For example, regarding the DC motor 40 in question, the reference rotation amount Ns and the reference induced current integral value Is, corresponding to various induced current values I₀ when the braking operation of the DC motor 40 is started, are examined and stored in the memory in advance. Then, the reference rotation amount Ns and the reference induced current integral value Is, corresponding to the induced current value I₀ actually estimated from the induced current attenuation curve, may be selected to obtain the rotation amount Na of the DC motor 40 during the braking operation according to the above equation 1.

Alternatively, a plurality of pieces of data, related to the actual induced current integral value Ia of the DC motor 40 during the braking operation and the actual rotation amount Na of the DC motor 40, may be measured, and based on the measured data, an equation or a map representing the relationship between the actual induced current integral value Ia and the actual rotation amount Na of the DC motor 40 may be created and stored in the memory. In this case, the actual rotation amount Na of the DC motor 40 can be estimated from the actual induced current integral value Ia using the equation or map stored in the memory.

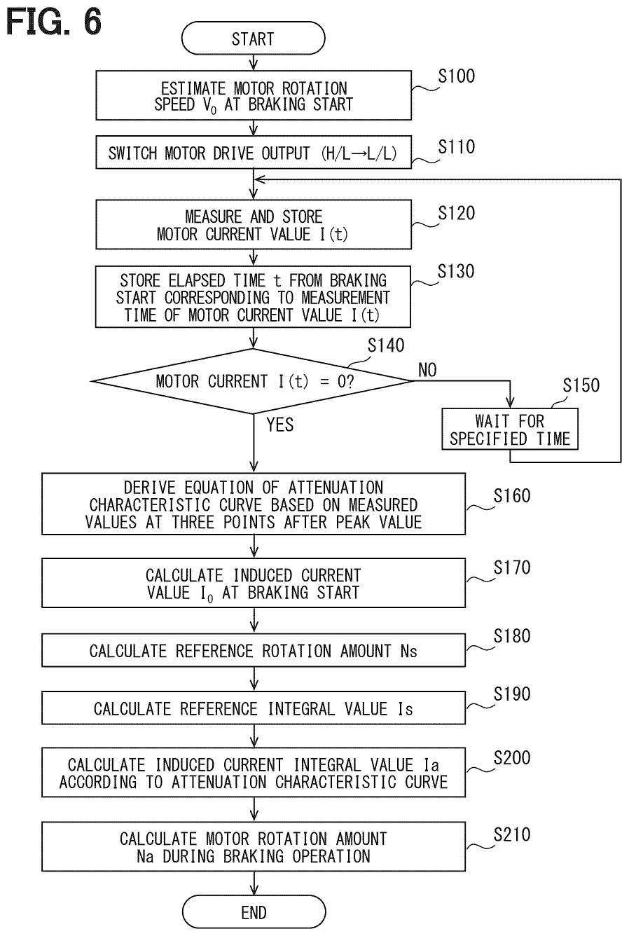

Next, an example of a process executed according to the programs in the motor control device 10 will be described with reference to the flowchart of FIG. 6. The process illustrated in the flowchart of FIG. 6 is for calculating the rotation amount Na of the DC motor 40 during the braking operation. This process is executed when the braking operation of the DC motor 40 is started.

In a first step S100, the motor control device 10 estimates the rotation speed V₀ of the DC motor 40 at the time when the braking operation is started on the basis of the rotation speed of the DC motor calculated by the rotation speed calculation unit 16. In a subsequent step S110, the motor control device 10 outputs, to the motor drive unit 30, a control signal for switching from a normal operation in which a drive voltage is applied across the positive terminal and negative terminal of the DC motor 40 to a braking operation in which the same potential is applied to the positive terminal and negative terminal of the DC motor 40.

In a step S120, the motor control device 10 measures a motor current value I(t) output from the motor current monitoring unit 50, and stores the value I(t) in the memory. In a step S130, the motor control device 10 acquires an elapsed time t from the start of the braking operation when the motor current value I(t) is measured, and stores the elapsed time t in the memory in association with the motor current value I(t). In a step S140, the motor control device 10 determines whether the measured motor current value I(t) can be regarded as substantially zero. When it is determined that the motor current value I(t) is not substantially zero, the motor control device 10 proceeds to a step S150. In the step S150, the motor control device 10 waits for a specified time. After waiting for the specified time, the motor control device 10 repeats the processing from the step S120.

On the other hand, when it is determined in the step S140 that the motor current value I(t) is substantially zero, the motor control device 10 proceeds to a step S160. Note that when it is determined in the step S140 that the motor current value I(t) is substantially zero, the elapsed time t associated with the motor current value I(t) becomes the time, tend, from the start of the braking operation to the stop of the rotation of the DC motor 40.

In the step S160, the motor control device 10 specifies a peak value of the motor current value I(t) after the start of the braking period on the basis of a plurality of the measured motor current values I(t). Then, based on the measured values (motor current values indicating induced current and corresponding elapsed times) at at least three points measured after the motor current value I(t) reaches the peak value, an equation indicating the attenuation characteristic curve of the induced current is derived. The peak value of the motor current value I(t) may or need not be included in the measured values at the at least three points described above.

In a step S170, the motor control device 10 calculates the induced current value I₀ when the braking operation of the DC motor 40 is started on the basis of the derived attenuation characteristic curve of the induced current. In a step S180, the motor control device 10 calculates the product of the rotation speed V0 of the DC motor at the time when the braking operation of the DC motor 40 is started and the time, tend, from the start of the braking operation to the stop of the rotation of the DC motor 40, as the reference rotation amount Ns. In a step S190, the motor control device 10 calculates the product of the induced current value I₀ when the braking operation of the DC motor 40 is started and the time, tend, from the start of the braking operation to the stop of the rotation of the DC motor 40, as the reference induced current integral value Is.

In a step S200, the motor control device 10 calculates the actual induced current integral value Ia during the braking operation period by integrating the induced current over the elapsed time, tend, according to the attenuation characteristic curve of the induced current derived in the step S160. Then, in a step S210, the motor control device 10 calculates the rotation amount Na of the DC motor 40 during the braking operation by multiplying the reference rotation amount Ns by the ratio of the actual induced current integral value Ia to the reference induced current integral value Is.

### Second Embodiment

Next, a during-braking rotation amount estimation device, a during-braking rotation amount estimation method, and a motor control device including the during-braking rotation amount estimation device according to a second embodiment of the present disclosure will be described in detail with reference to the drawings. Note that a during-braking rotation amount estimation device 11 and a motor control device 10 according to the present embodiment can be configured similarly to the first embodiment except for a configuration for measuring a time, tend, from the start of the braking operation to the stop of the rotation of a DC motor 40, and thus the description of the common configurations will be omitted.

In the first embodiment described above, it is determined in the step S140 of the flowchart of FIG. 6 whether the motor current value I(t) has become substantially zero, whereby the measurement of the motor current is continued until the rotation of the DC motor 40 is stopped.

However, if the measurement of the motor current is continued until the rotation of the DC motor 40 is stopped, and thereafter if the processing for deriving the attenuation characteristic curve is started based on the values measured at at least three measurement points, the process for detecting the rotation amount of the DC motor 40 takes time after the rotation of the DC motor 40 is stopped. Therefore, when restart is instructed immediately after the DC motor 40 is stopped, there is a risk that the DC motor 40 cannot be restarted with good responsiveness.

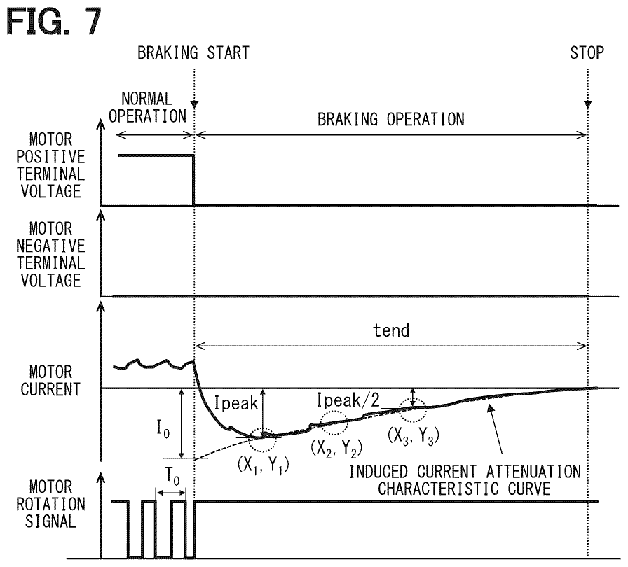

Therefore, in the present embodiment, the measurement at at least three measurement points for deriving the attenuation characteristic curve is completed before the motor current (induced current) becomes zero, as illustrated in the time chart of FIG. 7. As a result, even when restart is instructed immediately after the DC motor 40 is stopped, the DC motor 40 can be restarted with good responsiveness to the instruction of the restart.

For example, in the example illustrated in FIG. 7, measurement at one measurement point (X₁, Y₁) is performed immediately after the motor current reaches a peak. Measurement at a third measurement point (X₃, Y₃) is performed when the motor current reaches ½ of the induced current value I₀ at the start of the braking operation. Measurement at the second measurement point (X₂, Y₂) is performed at around the approximate midpoint between the first measurement point (X₁, Y₁) and the third measurement point (X₃, Y₃). The timing when the measurement at the third measurement point is performed is not limited to when the motor current reaches ½ of the induced current value I₀ at the start of the braking operation. In the present embodiment, the motor current is not measured until the rotation of the DC motor 40 is stopped, and hence a time, tend, from the start of the braking operation to the stop of the rotation of the DC motor 40 is estimated and calculated on the basis of the derived attenuation characteristic curve.

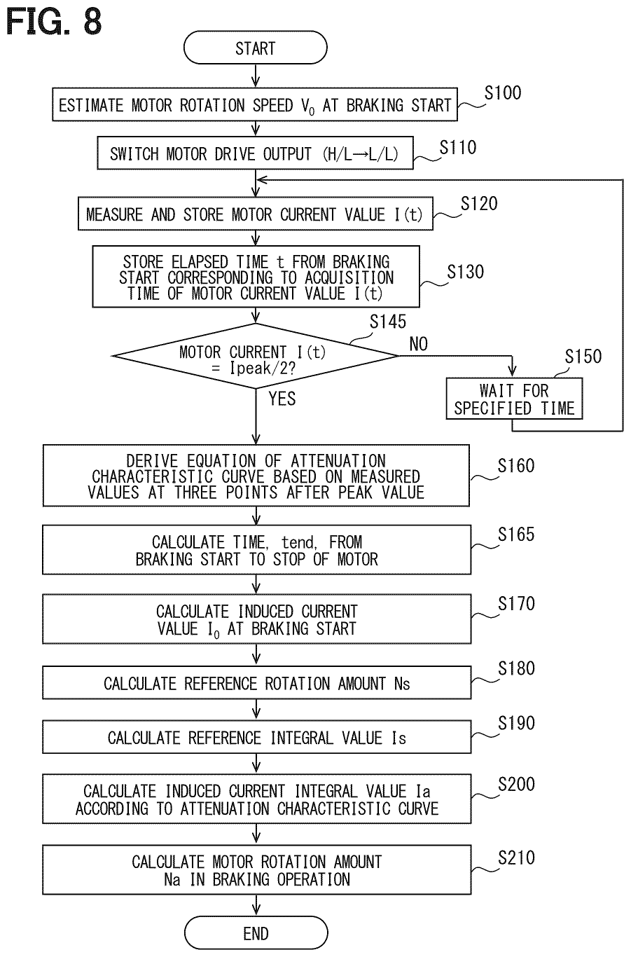

FIG. 8 illustrates an example of a flowchart illustrating a process executed by the motor control device 10 according to the present embodiment to calculate a rotation amount Na of the DC motor 40 during the braking operation. The flowchart of FIG. 8 is different from the flowchart of FIG. 6 in that the processing of the step S140 is changed to the processing of a step S145 and the processing of a step S165 is added. Since the processing of the other steps is not changed, the description thereof will be omitted.

In the step S145, the motor control device 10 does not determine whether the motor current value I(t) has become substantially zero, but determines whether the motor current value I(t) has reached ½ of the induced current value I₀ at the start of the braking operation. When determining that the motor current value I(t) has reached ½ of the induced current value I₀ at the start of the braking operation, the motor control device 10 proceeds to processing for deriving the attenuation characteristic curve of the induced current on the basis of the measured values at the at least three points in the step S160. Therefore, according to the present embodiment, the motor control device 10 can complete the measurement at the at least three measurement points before the motor current (induced current) becomes zero and start the process for calculating the rotation amount of the DC motor 40 during the braking operation.

In the step S165, the time, tend, from the start of the braking operation to the stop of the rotation of the DC motor 40 is calculated on the basis of the attenuation characteristic curve derived in the step S160. Therefore, without actually measuring the time, tend, from the start of the braking operation to the stop of the rotation of the DC motor 40, the reference rotation amount Ns, the reference induced current integral value Is, and the actual induced current integral value Ia can be calculated using the time, tend, from the start of the braking operation to the stop of the rotation of the DC motor 40 in the steps S180, S190, and S200.

Although preferred embodiments of the present disclosure have been described above, the present disclosure is not limited to the above-described embodiments. In other words, the present disclosure can be variously modified and implemented without departing from the gist of the present disclosure described in the claims.

What is claimed is:

1. A rotation amount estimation device configured to estimate a rotation amount of a brushed DC motor in a braking operation, the rotation amount estimation device comprising:
at least one of (i) a circuit and (ii) a processor with a memory storing computer program code executable by the processor, the at least one of the circuit and the processor configured to cause the rotation amount estimation device to:
estimate, when the DC motor stops rotation through the braking operation of the DC motor by stopping supply of a drive current to the DC motor and applying a same potential to both terminals of the DC motor, an attenuation characteristic curve indicating a characteristic of attenuation of an induced current from start of the braking operation to stop of the rotation of the DC motor, based on the induced current flowing through the DC motor in the braking operation of the DC motor;
estimate a time required from the start of the braking operation to the stop of the rotation of the DC motor; and
estimate the rotation amount of the DC motor in the braking operation based on an integral value obtained by integrating the induced current over the time as estimated according to the attenuation characteristic curve of the induced current as estimated.

2. The rotation amount estimation device according to claim 1, wherein
the at least one of the circuit and the processor is configured to cause the rotation amount estimation device to derive the attenuation characteristic curve based on values of the induced current at at least three points in the braking operation of the DC motor and times when the values of the induced current at the at least three points are acquired.

3. The rotation amount estimation device according to claim 2, wherein
the at least one of the circuit and the processor is configured to cause the rotation amount estimation device to derive the attenuation characteristic curve that is a quadratic function curve.

4. The rotation amount estimation device according to claim 2, wherein
the at least one of the circuit and the processor is configured to cause the rotation amount estimation device to acquire, after the induced current reaches a peak value, the values of the induced current at the at least three points and the times when the values of the induced current at the at least three points are acquired.

5. The rotation amount estimation device according to claim 2, wherein
the at least one of the circuit and the processor is configured to cause the rotation amount estimation device to complete, before the induced current becomes zero, acquisition of the values of the induced current at the at least three points and the times when the values of the induced current at the at least three points are acquired.

6. The rotation amount estimation device according to claim 5, wherein
the at least one of the circuit and the processor is configured to cause the rotation amount estimation device to acquire the time required from the start of the braking operation to the stop of the rotation of the DC motor from the attenuation characteristic curve as estimated.

7. The rotation amount estimation device according to claim 1, wherein
the at least one of the circuit and the processor is configured to cause the rotation amount estimation device to:
calculate a rotation speed of the DC motor based on a waveform of a current flowing through the DC motor when the DC motor is rotationally driven with a drive current supplied to the DC motor;
calculate, as a reference rotation amount, a product of a rotation speed of the DC motor, which is estimated based on the rotation speed of the DC motor as calculated at a time when the braking operation of the DC motor is started, and the time required from the start of the braking operation to the stop of the rotation of the DC motor;
calculate, as a reference integral value, a product of a value of the induced current at the start of the braking operation of the DC motor and the time required from the start of the braking operation to the stop of the rotation of the DC motor, the value and the time being estimated from the attenuation characteristic curve; and
calculate the rotation amount of the DC motor in the braking operation by multiplying the reference rotation amount by a ratio of the integral value to the reference integral value.

8. A motor control device comprising:
the rotation amount estimation device according to claim 1, wherein
the at least one of the circuit and the processor is configured to cause the rotation amount estimation device to:
detect a rotation amount when the DC motor is stopped by adding the rotation amount of the DC motor in the braking operation as estimated to the rotation amount of the DC motor until the supply of the drive current to the DC motor is stopped, the rotation amount being calculated based on the waveform of a current flowing through the DC motor; and
control the supply of the drive current to the DC motor based on the rotation amount of the DC motor as detected.

9. The motor control device according to claim 8, wherein
the DC motor is configured to open and close a window of a vehicle, and
the at least one of the circuit and the processor is configured to cause the rotation amount estimation device to:
execute anti-pinch control for stopping or reversing the DC motor, when pinch occurs due to the window in a middle of closing the window; and
stop the anti-pinch control, when determining that a predetermined distance to a position where the window is closed has been reached based on the rotation amount of the DC motor as detected.

10. A rotation amount estimation method for estimating a rotation amount of a brushed DC motor in a braking operation executed by at least one processor, the rotation amount estimation method comprising:
first estimating, when rotation of the DC motor is stopped through the braking operation of the DC motor by stopping supply of a drive current to the DC motor and applying a same potential to both terminals of the DC motor, an attenuation characteristic curve indicating a characteristic of attenuation of an induced current from start of the braking operation to stop of the rotation of the DC motor, based on the induced current flowing through the DC motor in the braking operation of the DC motor;
second estimating a time required from the start of the braking operation to the stop of the rotation of the DC motor; and
third estimating the rotation amount of the DC motor in the braking operation based on an integral value obtained by integrating the induced current over the time as estimated according to the attenuation characteristic curve of the induced current as estimated.

11. The rotation amount estimation method according to claim 10, wherein
the first estimating includes deriving the attenuation characteristic curve based on values of the induced current at at least three points and times when the values of the induced current at the at least three points are acquired in the braking operation of the DC motor.

12. The rotation amount estimation method according to claim 11, wherein
the first estimating includes deriving the attenuation characteristic curve that is a quadratic function curve.

13. The rotation amount estimation method according to claim 11, wherein
the first estimating includes acquiring the values of the induced current at the at least three points and the times when the values of the induced current at the at least three points are acquired after the induced current reaches a peak value.

14. The rotation amount estimation method according to claim 11, wherein
the first estimating includes completing acquisition of the values of the induced current at the at least three points and the times when the values of the induced current at the at least three points are acquired before the induced current becomes zero.

15. The rotation amount estimation method according to claim 14, wherein
the second estimating includes obtaining the time required from the start of the braking operation to the stop of the rotation of the DC motor from the attenuation characteristic curve as estimated.

16. The rotation amount estimation method according to claim 10, further comprising:
calculating, while the DC motor is rotationally driven with a drive current supplied to the DC motor, a rotation speed of the DC motor based on a waveform of the current flowing through the DC motor, wherein
the third estimating includes:
calculating, as a reference rotation amount, a product of a rotation speed of the DC motor, which is estimated based on the rotation speed of the DC motor as calculated at a time when the braking operation of the DC motor is started, and the time required from the start of the braking operation to the stop of the rotation of the DC motor;
calculating, as a reference integral value, a product of a value of the induced current when the braking operation of the DC motor is started and the time required from the start of the braking operation to the stop of the rotation of the DC motor, the value and the time being estimated from the attenuation characteristic curve; and
calculating the rotation amount of the DC motor in the braking operation by multiplying the reference rotation amount by a ratio of the integral value to the reference integral value.

17. A rotation amount estimation device configured to estimate a rotation amount of a brushed DC motor in a braking operation, the rotation amount estimation device comprising:
an attenuation characteristic curve estimation unit configured to estimate, when the DC motor stops rotation through the braking operation of the DC motor by stopping supply of a drive current to the DC motor and applying a same potential to both terminals of the DC motor, an attenuation characteristic curve indicating a characteristic of attenuation of an induced current from start of the braking operation to stop of the rotation of the DC motor, based on the induced current flowing through the DC motor in the braking operation of the DC motor;
a time estimation unit configured to estimate a time required from the start of the braking operation to the stop of the rotation of the DC motor; and
a rotation amount estimation unit configured to estimate the rotation amount of the DC motor in the braking operation based on an integral value obtained by integrating the induced current over the time estimated by the time estimation unit according to the attenuation characteristic curve of the induced current estimated by the attenuation characteristic curve estimation unit.
